(19) United States
(12) Patent Application Publication
(10) Pub. No.: US 2026/0268597 A1
(43) Pub. Date: Sep. 10, 2026

(54) AVATAR SIGNALING IN SCENE DESCRIPTION

(71) Applicant: InterDigital CE Patent Holdings, SAS, Paris (FR)

(72) Inventors: João Pedro COVA REGATEIRO, Chateaubourg (FR); Philippe GUILLOTEL, VERN SUR SEICHE (FR); Quentin AVRIL, BETTON (FR); Philippe Henri GOSSELIN, Liffré (FR)

(21) Appl. No.: 19/167,324

(22) PCT Filed: Mar. 15, 2024
(86) PCT No.: PCT/EP2024/057092

§ 371 Date: Sep. 19, 2025

(30) Foreign Application Priority Data
Mar. 24, 2023 (EP) 23305405.5

(51) Int. Cl. G06T 17/00; G06T 13/40; G06T 19/00

(52) U.S. Cl. CPC G06T 17/00; G06T 13/40; G06T 19/006

(57) ABSTRACT

In one implementation, we propose to provide signaling to inform applications about what to expect from the avatar node. The representation of the proposed format is reconstructed given some user inputs, and mapped onto a 3D reference avatar model, to allow a shared geometry and feature representation for any humanoid character. For example, the “format” and “model” attributes provide additional information relative to an avatar, such as the avatar format, high-level semantics, and 3D media linked to geometry or texture. For a 3D model, the type of avatar and the skeletal structure can also be described. This common base representation facilitates animation and representation of different morphologies or contexts. Such a high-level semantic description is less costly in terms of network transmission and also enables easy transcoding between different formats.

### TECHNICAL FIELD

The present embodiments generally relate to digital human representation and interaction within 3D-engineered virtual scenes, more particularly, to identify an avatar used under an avatar node in scene description.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF (Graphics Language Transmission Format) and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Scene description frameworks ensure that the timed media and the corresponding relevant virtual content are available at any time during the rendering of the application. Scene descriptions can also carry data at scene level describing how a user can interact with the scene objects at runtime for immersive XR experiences.

### SUMMARY

According to an embodiment, a method is presented, comprising: obtaining a format used to represent an avatar, from a description for an extended reality scene; obtaining from said description at least a type of avatar; and reconstructing said avatar, based on said format and said at least a type of avatar.

According to another embodiment, a method is presented, comprising: indicating a format used to represent an avatar, in a description for an extended reality scene; indicating at least a type of avatar in said description; generating data representative of said avatar based on said format and said at least a type of avatar; and indicating said data representative of said avatar in said description.

According to another embodiment, an apparatus is presented, comprising: one or more processors; and at least one memory coupled to said one or more processors, wherein said one or more processors are configured to: obtain a format used to represent an avatar, from a description for an extended reality scene; obtain from said description at least a type of avatar; and reconstruct said avatar, based on said format and said at least a type of avatar.

According to another embodiment, an apparatus is presented, comprising: one or more processors; and at least one memory coupled to said one or more processors, wherein said one or more processors are configured to: indicate a format used to represent an avatar, in a description for an extended reality scene; indicate at least a type of avatar in said description; generate data representative of said avatar based on said format and said at least a type of avatar; and indicate said data representative of said avatar in said description.

One or more embodiments also provide a computer program comprising instructions which when executed by one or more processors cause the one or more processors to perform the method according to any of the embodiments described herein. One or more of the present embodiments also provide a computer readable storage medium having stored thereon instructions for processing scene description according to the methods described herein.

One or more embodiments also provide a computer readable storage medium having stored thereon a scene description generated according to the methods described above. One or more embodiments also provide a method and apparatus for transmitting or receiving the scene description generated according to the methods described herein.

### BRIEF DESCRIPTION OF THE DRAWINGS

FIG. 1 shows an example architecture of an XR processing engine.

FIG. 2 shows an example of the syntax of a data stream encoding an extended reality scene description.

FIG. 3 shows an example graph of an extended reality scene description.

FIG. 4 shows an example of an extended reality scene description.

FIG. 5 illustrates the current solution to represent avatars in MPEG-I Scene Description (SD).

FIG. 6 illustrates what information is encoded in the avatar encoder and the different possible renderings, according to an embodiment.

FIG. 7 illustrates avatar representation for network transmission and mobile rendering, according to an embodiment.

FIG. 8 illustrates semantics mapping for animation control between a MPEG reference model and a VRM model, according to an embodiment.

FIG. 9 illustrates semantic blend shapes for facial mapping for animation control between a MPEG reference model and a VRM model, according to an embodiment.

FIG. 10A and FIG. 10B illustrate semantical mapping and motion transfer using the MPEG reference model, according to an embodiment.

FIG. 11A and FIG. 11B illustrate the rig parameters.

### DETAILED DESCRIPTION

Various XR applications may apply to different context and real or virtual environments. For example, in an industrial XR application, a virtual 3D content item (e.g., a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a furniture is displayed when a given image from the catalog is detected in the input camera view. The 3D content is positioned in the real-world with a position and scale defined relatively to the detected reference image. In another application, some audio file might start playing when the user enters an area close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, bird characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger. Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree comprises only virtual objects descriptions.

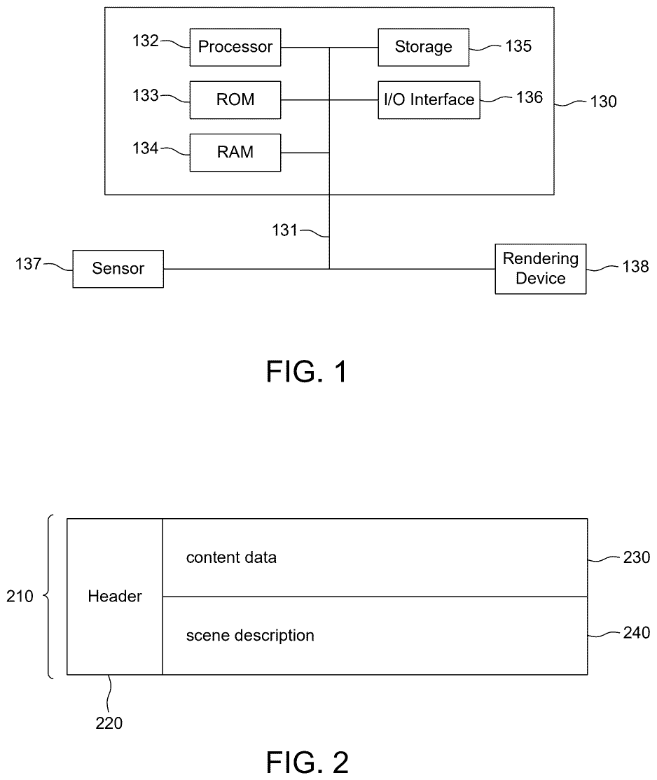

FIG. 1 shows an example architecture of an XR processing engine 130 which may be configured to implement the methods described herein. A device according to the architecture of FIG. 1 is linked with other devices via their bus 131 and/or via I/O interface 136.

Device 130 comprises following elements that are linked together by a data and address bus 131:
a microprocessor 132 (or CPU), which is, for example, a DSP (or Digital Signal Processor);
a ROM (or Read Only Memory) 133;
a RAM (or Random Access Memory) 134;
a storage interface 135;
an I/O interface 136 for reception of data to transmit, from an application; and
a power supply (not represented in FIG. 1), e.g., a battery.

In accordance with an example, the power supply is external to the device. In each of mentioned memory, the word “register” used in the specification may correspond to area of small capacity (some bits) or to very large area (e.g., a whole program or large amount of received or decoded data). The ROM 133 comprises at least a program and parameters. The ROM 133 may store algorithms and instructions to perform techniques in accordance with present principles. When switched on, the CPU 132 uploads the program in the RAM and executes the corresponding instructions.

The RAM 134 comprises, in a register, the program executed by the CPU 132 and uploaded after switch-on of the device 130, input data in a register, intermediate data in different states of the method in a register, and other variables used for the execution of the method in a register.

Device 130 is linked, for example via bus 131 to a set of sensors 137 and to a set of rendering devices 138. Sensors 137 may be, for example, cameras, microphones, temperature sensors, Inertial Measurement Units, GPS, hygrometry sensors, IR or UV light sensors or wind sensors. Rendering devices 138 may be, for example, displays, speakers, vibrators, heat, fan, etc.

In accordance with examples, the device 130 is configured to implement a method according to the present principles, and belongs to a set comprising:
a mobile device;
a communication device;
a game device;
a tablet (or tablet computer);
a laptop;
a still picture camera;
a video camera.

In XR applications, scene description is used to combine explicit and easy-to-parse description of a scene structure and some binary representations of media content. FIG. 2 shows an example of the syntax of a data stream encoding an extended reality scene description. FIG. 2 shows an example structure 210 of an XR scene description. The structure consists in a container which organizes the stream in independent elements of syntax. The structure may comprise a header part 220 which is a set of data common to every syntax element of the stream. For example, the header part comprises some of metadata about syntax elements, describing the nature and the role of each of them. The structure also comprises a payload comprising an element of syntax 230 and an element of syntax 240. Syntax element 230 comprises data representative of the media content items described in the nodes of the scene graph related to virtual elements. Images, meshes and other raw data may have been compressed according to a compression method. Element of syntax 240 is a part of the payload of the data stream and comprises data encoding the scene description as described according to the present principles.

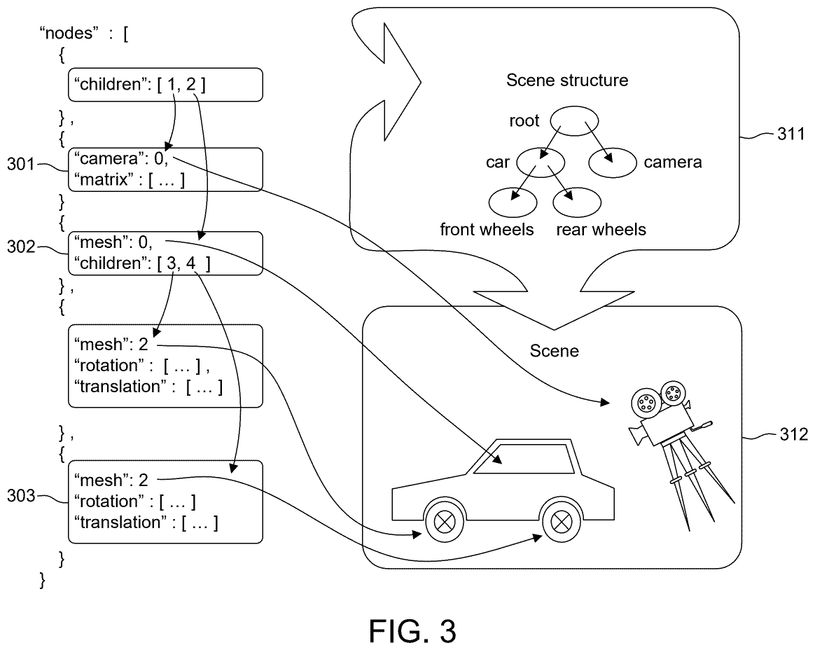

FIG. 3 shows an example graph 310 of an extended reality scene description. In this example, the scene graph may comprise a description of real objects, for example ‘plane horizontal surface’ (that can be a table or a road) and a description of virtual objects 312, for example an animation of a car. Scene description is organized as an array of nodes. A node can be linked to child nodes to form a scene structure 311. A node can carry a description of a real object (e.g., a semantic description) or a description of a virtual object. In the example of FIG. 3, node 301 describes a virtual camera located in the 3D volume of the XR application. Node 302 describes a virtual car and comprises an index of a representation of the car, for example an index in an array of 3D meshes. Node 303 is a child of node 302 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 310 also comprises nodes that are a description of the spatial relation between the real objects and the virtual objects.

In time-based media streaming, the scene description itself can be time-evolving to provide the relevant virtual content for each sequence of a media stream. For instance, for advertising purpose, a virtual bottle can be displayed on a table during a video sequence where people are seated around the table. This kind of behavior can be achieved by relying on the framework defined in the Scene Description for MPEG media document.

Currently, the MPEG-I Scene Description framework uses “behavior” data to augment the time-evolving scene description and provides description of how a user can interact with the scene objects at runtime for immersive XR experiences. These behaviors are related to pre-defined virtual objects on which runtime interactivity is allowed for user specific XR experiences. These behaviors are also time-evolving and are updated through the existing scene description update mechanism.

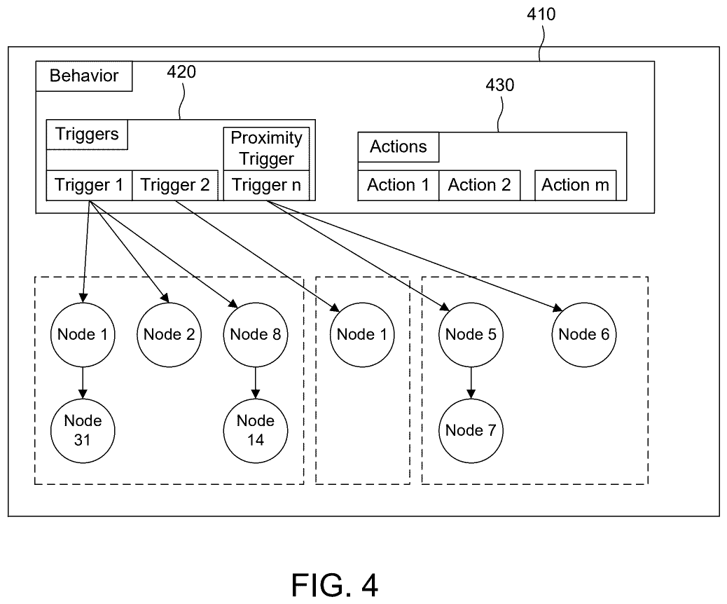

FIG. 4 shows an example of an extended reality scene description comprising behavior data, stored at scene level, describing how a user can interact with the scene objects, described at node level, at runtime for immersive XR experiences. When the XR application is started, media content items (e.g., meshes of virtual objects visible from the camera) are loaded, rendered and buffered to be displayed when triggered. For example, when a plane surface is detected in the real environment by sensors, the application displays the buffered media content item as described in related scene nodes. The timing is managed by the application according to features detected in the real environment and to the timing of the animation. A node of a scene graph may also comprise no description and only play a role of a parent for child nodes. FIG. 4 shows relationships between behaviors that are comprised in the scene description at the scene level and nodes that are components of the scene graph. Behaviors 410 are related to pre-defined virtual objects on which runtime interactivity is allowed for user specific XR experiences. Behavior 410 is also time-evolving and is updated through the scene description update mechanism.

A behavior comprises:
triggers 420 defining the conditions to be met for its activation;
a trigger control parameter defining logical operations between the defined triggers;
actions 430 to be proceeded processed when the triggers are activated;
an action control parameter defining the order of execution of the related actions;
a priority number enabling the selection of the behavior of highest priority in the case of competition between several behaviors on the same virtual object at the same time;
an optional interrupt action that specifies how to terminate this behavior when it is no longer defined in a newly received scene update; for instance, a behavior is no longer defined if a related object does not belong to the new scene or if the behavior is no longer relevant for this current media (e.g., audio or video) sequence.

Behavior 410 takes place at scene level. A trigger is linked to nodes and to the nodes' child nodes. In the example of FIG. 4, Trigger 1 is linked to nodes 1, 2 and 8. As Node 31 is a child of node 1, Trigger 1 is linked to node 31. Trigger 1 is also linked to node 14 as a child of node 8. Trigger 2 is linked to node 1. Indeed, a same node may be linked to several triggers. Trigger n is linked to nodes 5, 6 and 7. A behavior may comprise several triggers. For instance, a first behavior may be activated by trigger 1 AND trigger 2, AND being the trigger control parameter of the first behavior. A behavior may have several actions. For instance, the first behavior may perform Action m first and, then action 1, “first and then” being the action control parameter of the first behavior. A second behavior may be activated by trigger n and perform action 1 first and, then action 2, for example.

Different formats can be used to represent the node tree. For example, the MPEG-I Scene Description framework using the Khronos glTF extension mechanism may be used for the node tree. In this example, an interactivity extension may apply at the glTF scene level and is called MPEG_scene_interactivity. The corresponding semantic is provided in Table 1, where ‘M’ in ‘Usage’ column indicates that the field is mandatory in a XR scene description format and ‘O’ indicates the field is optional.

TABLE 1

| Name | Type | Usage | Description |
|---|---|---|---|
| triggers | Array | M | Contains the definition of all the triggers |
| | | | used in that scene. |
| actions | Array | M | Contains the definition of all the actions |
| | | | used in that scene. |
| behaviors | Array | M | Contains the definition of all the behaviors |
| | | | used in that scene. A behavior is composed |
| | | | of a pair of (triggers, actions), control |
| | | | parameters of triggers and actions, a |
| | | | priority weight and an optional interrupt |
| | | | action. |

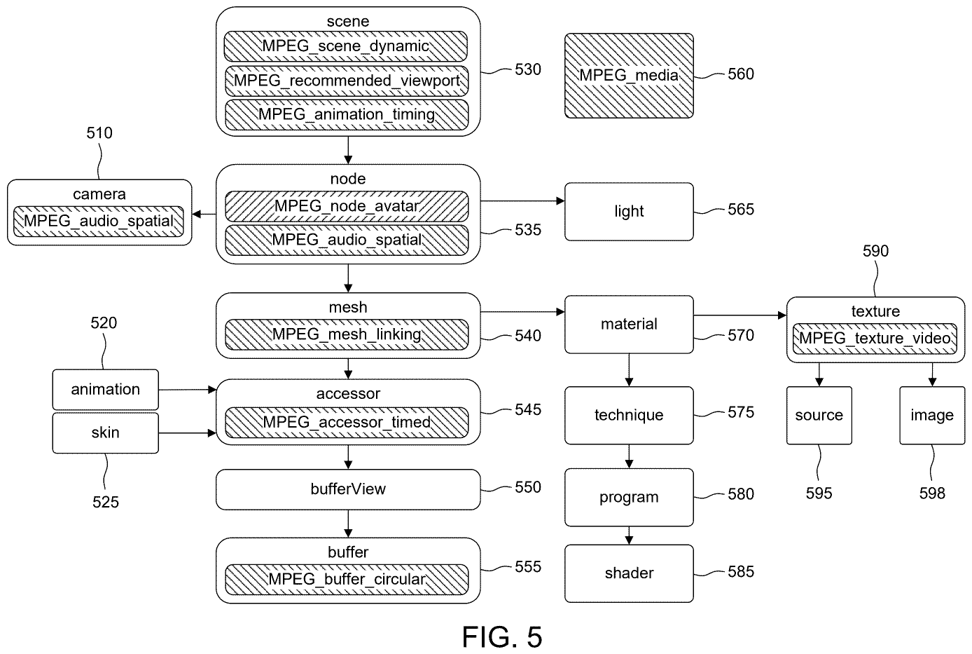

FIG. 5 illustrates the current solution to represent avatars in MPEG-I Scene Description (SD). In particular, FIG. 5 represents a glTF file structure. The entry point is the “scene” node (530) which contains “node” node(s) (535) that can be either a “camera” (510), a “light” (565) or a “mesh” (540). The MPEG-I SD has defined a new Boolean attribute “MPEG_node_avatar” (535) indicating whether the node corresponds to an avatar node or not, as illustrated in Table 2. The purpose of this Boolean attribute is to define which node defines the user representation.

Today, this approach is limited as it does not provide any visual or animation information on the avatar asset. Such information has to be explicitly defined on the nodes below. For appearance, it is defined as “material” (570) with “texture” (590) that is referenced either by a direct “source” (595) or an “image” (598), “technique” (575), “program” (580) and “shader” (585). For the animation it is defined in “accessor” (545) with “animation” (520) and “skin” (525). They are all displayed using “bufferView” (550) and “buffer” nodes information (555). The “MPEG_media” (560) can redefine some existing attributes, such as geometry, appearance, sound, haptics and/or animation by referring to external data.

TABLE 2

| Name | Type | Usage | Default | Description |
|---|---|---|---|---|
| isAvatar | boolean | M | True | Indicate if the object is an active |
| | | | | avatar. |

Using a Boolean to represent an avatar is limited as it does not provide any visual or animation information on the avatar asset. An avatar component needs to accurately express different types of avatar representations that have distinct ways of initialization, manipulation, or representation. MPEG-I SD presents a reference avatar (“MPEG_reference_avatar”), which contains several attributes, such as geometry for eyes, jaws, face, body, or detailed semantical description of body parts. These attributes (eyes, jaws, face, body and semantics) are not exclusive to one avatar representation, as it can in general represent a human body. In practice other avatar representations might contain additional details to their own representation, which are nevertheless compatible with the presented reference avatar. Therefore, the unique avatar representation in MPEG-I SD is insufficient when dealing with the reference avatar or any other avatar representation.

This document aims to signal what type of avatar representation an avatar node (e.g., “MPEG_node_avatar”) refers to so that the application side can query the correct assets and build the valid semantical regions.

### Avatar Signalling in MPEG-I Scene Description

In the current document, the proposed format follows the glTF format and is compatible with the recent MPEG-I SD effort to extend glTF with MPEG-I SD extensions. However, the meaning and use are generic and can be coded in other formats (e.g., XML, USD).

In current MPEG-I, the geometry of an avatar is defined, however, the semantics (e.g., high-level description of body parts, such as which vertices represent the left or right hand, the head or legs, or high level description of the type of avatar, such as humanoid or not) are not defined and a client/engine will not necessarily know how to process the avatar. Therefore, we propose to provide signaling to inform applications about what to expect from the avatar node (e.g., “MPEG_node_avatar”).

In one embodiment, an avatar should then respect the following requirements:
1. An avatar is represented by a node designated for avatars. For example, “MPEG_node_avatar” is used to designate an avatar node for MPEG-I, and any other character representation is not qualified as an “avatar” under the MPEG-I SD standards.
2. The reconstruction and animation respect the supported primitives in the scene description for MPEG and/or other standard and animation formats.
3. An avatar may or may not be explicitly represented by the “format” accompanied by the respective URI to the 3D asset.
4. If an avatar sets the “format”, the default is “MPEG” and is fully supported by the MPEG-I SD standard for reconstruction and animation.
5. Any other “format” representation must contain a 3D mesh media to allow reconstruction by the user application.

The representation of the proposed format is reconstructed, given some user inputs, and mapped onto the 3D avatar model, for example, “MPEG_reference_avatar” which contains a full body-based mesh representation, skeleton and skinning weights, facial blend shapes and landmarks, and additional geometry including, eyes, jaws, teeth and tongue. This allows a shared geometry and feature representation for any humanoid character (of course, appropriate deformation allows to adapt the shape). This common base representation facilitates animation and representation of different morphologies or contexts.

This “format” extension provides a signal to identify the avatar used under the avatar node (“MPEG_node_avatar”). Given the proposed extension property, the client will know what avatar to reconstruct/render. The default representation is the reference avatar (“MPEG_avatar_reference”), which is fully supported under this proposed extension.

If a node in the scene graph is an avatar node, then the format described in Table 3 is considered, otherwise is ignored.

Table 3 describes the new proposed attributes to support the signaling “isAvatar” in Table 2. The “format” and “model” attributes provide additional information relative to an avatar, such as avatar format, high-level semantics, and 3D media linked to geometry or texture.

TABLE 3

| Name | Type | Usage | Description |
|---|---|---|---|
| format | number | O | Indicates in which 3D format as defined in |
| | | | TABLE 4 the avatar is represented. The |
| | | | default value is 1. |
| model | array | O | Avatar model (see TABLE 5). If present |
| | | | refers to a 3D media object and its |
| | | | specifications. |

Table 4 lists the 3D formats that can be used to represent the avatar.

TABLE 4

| Index | Format |
|---|---|
| 0 | unspecified |
| 1 | “MPEG” |
| 2 | SMPL |
| 3 | VRM |
| 4 | MANO |
| 5 | FAUST |
| 6 | Dynamic FAUST |
| 7 | SMAL |
| 8 | FLAME |
| . . . | Reserved for future use |

Table 5 illustrates semantical descriptions of property “model”. It introduces the semantics and media of the avatar model.

TABLE 5

| Name | Type | Usage | Description |
|---|---|---|---|
| name | string | M | User-defined name of the 3D media. |
| type | array | M | A list of strings to indicate which |
| | | | avatar type the media refers to, an |
| | | | example of different types is defined |
| | | | in TABLE 6. This attribute signals |
| | | | the engine how to animate or manipulate |
| | | | the avatar. The table presents the |
| | | | higher level representation depending |
| | | | on styles of motion and skeletal |
| | | | structure. We can combine several items |
| | | | from this list or from other more |
| | | | detailed representations (e.g., jumping, |
| | | | gliding, swimming, etc..) to facilitate |
| | | | the client application to parse the type |
| | | | of avatar and its ability to move. |
| resolution | array | M | A list that semantically describes |
| | | | each element in the media array in terms |
| | | | of resolution of the media e.g., |
| | | | low-resolution, medium-resolution, or |
| | | | high-resolution. This is subject to |
| | | | application specification. The resolution |
| | | | is index aligned with the media array. |
| | | | Hence it allows the application to select |
| | | | media depending on the application's |
| | | | performance capabilities. |
| skeleton | array | O | Avatar skeletal structure (see TABLE 7). |
| | | | If present provides the avatar skeletal |
| | | | attributes and mechanism to edit and |
| | | | manipulate the media geometry. |
| media | array | M | An array of items that indicates |
| | | | alternatives of the same 3D media object |
| | | | (e.g., different levels of detail). |
| | | | Each item corresponds to an MPEG_media. |
| | | | The client could select the MPEG_media |
| | | | depending on the client's capability. |

Table 6 lists an example of different avatar types.

TABLE 6
Avatar Type

Humanoid
Animal
Aquatic
Aerial
Terrestrial
Subterranean
Arboreal
Other

Table 7 illustrates avatar skeletal structure semantics description containing naming for the joints, 3D position, bone structure, influence between bones and geometry and high level semantic control points to create another level of manipulation.

TABLE 7

| Name | Type | Usage | Description |
|---|---|---|---|
| semantics | array | O | A list of strings that represents |
| | | | the semantic descriptions of the |
| | | | joints. |
| joints | array | O | A list of 3D positions that builds |
| | | | the internal skeletal joints of the |
| | | | avatar. |
| bones | array | O | A list of pairs of joint indices |
| | | | that forms bone connectivity between |
| | | | joints and permit the construction |
| | | | of a hierarchical skeletal graph. |
| bone_influence | array | O | A list of bones that influences over |
| | | | the geometry vertices. For every |
| | | | vertex, a list of bones is assigned |
| | | | with a floating scalar associated. |
| | | | This scalar is called weight, and |
| | | | for every bone assigned to a vertex, |
| | | | its sum should be equal to 1. |
| control_points | array | O | Higher semantical representation that |
| | | | facilitates the manipulation of several |
| | | | aggregate bones, simplifying the |
| | | | process of animation. This is formed |
| | | | by a list of 3D positions in space |
| | | | (anchors) and a deformation space |
| | | | that contains several bone indices |
| | | | to perform the control of the region |
| | | | surrounding the control point. |

The media attribute is defined by the “MPEG_media.media.alternative” described in the MPEG_media extension in ISO/IEC 23090-14 Scene description specification, which contains the “uri” and “mimeType” that are used to reference any media input format. media is an array of MPEG_media.

glTF Schemas Example

The following glTF will instantiate an “MPEG_node_avatar” in clients that support this extension and, otherwise, fall back to a standard “MPEG_node” without the semantical extension.

The following example illustrates a glTF format using MPEG extensions. This example demonstrates a “MPEG_node_avatar” node extension to support the basic representation of avatars in MPEG SD. In this “MPEG_node_avatar” node, we instantiate the model with a “format=1” that refers to the MPEG reference avatar. The “type” identifies semantically the avatar and its motion ability, e.g., “Terrestrial” with ability to walk and run, and can be manipulated (“Articulated”). It provides two levels of resolution (“low-res” and “high-res”) and an example (not complete) of the “skeleton” object structure.

```
“nodes”: [
  {
    “extensions”: {
      “MPEG_node_avatar”: {
        “isAvatar”: True,
        “format”: 1,
        “model” : [{
          “name”: “MORGAN”,
          “type”: [“humanoid”, “Terrestrial”, “walking/running”, “Articulated”],
          “resolution”:[“low-res”,“high-res”],
          “skeleton”: [
            {
              “semantics”:[“hip”,“spine”, ...],
              “joints”:[[0.0,0.0,0.0], [0.0,1.0,0.0] ...],
              “bones”:[(0,1)],
              “bone_influence”:[(0,[0,1],[0.5,0.5]), ...],
              “control_points”: [([0.0,0.5,0.5], [0]), ...]
            }
          ],
          “media”: [
            {
              “uri”: “MPEG_avatar_reference_low.gltf”
              “mimeType”: “mesh/gltf”
            },
            {
              “uri”: “MPEG_avatar_reference_high.gltf”
              “mimeType”: “mesh/gltf”
            }
          ]
      }
    }
  }
]
```

### Use Cases

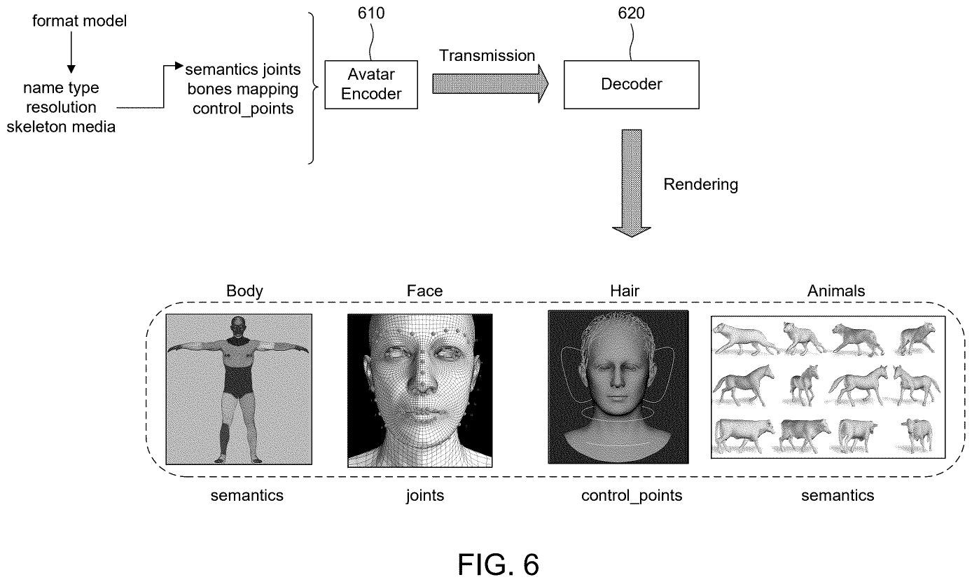

The purpose of this use case is to demonstrate the new features provided by the additional signaling. The proposed method facilitates the creation of a new codec format, which is tailored to avatar media formats. FIG. 6 illustrates a new avatar encoded representation (using the above glTF example) for lightweight network transmission and decoding of different avatar representations and contexts, according to an embodiment.

In particular, FIG. 6 demonstrates what information is encoded in the “Avatar Encoder” module (610) and the different possible renderings. As shown in FIG. 6, the following information is to be encoded is this example:
format
model
   name
   type
   resolution
   skeleton
      semantics
      joints
      bones
      bone_influence
      control_points
   media

In this example, the decoder (620) has the objective of interpreting the transmitted bits in a readable form, so the rendering can take the shape of, for example, a human body with semantical description, a head model with facial joints landmarks, a hair model with control animation points, or animals' 3D geometries with semantical categories, as illustrated in FIG. 6. The avatar encoder (610) and decoder (620) can be, for example, glTF encoder and decoder.

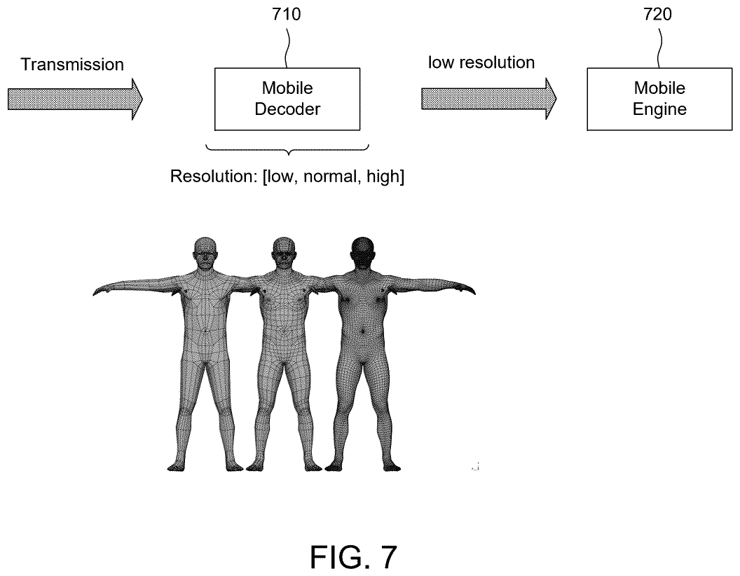

FIG. 7 illustrates avatar encoder representation for lightweight network transmission and mobile rendering through the “resolution” parameter that offers multiple options depending on the application, according to an embodiment.

In particular, FIG. 7 illustrates the usability of such codec for lightweight mobile decoders, that need information about the resolution of the geometric model. In this example, the mobile decoder (710) will have access to high-level information about the content e.g., if the geometry is of high or low resolution. This facilitates the choice of geometric models to load, given the performance capabilities of a given mobile device. In FIG. 7, we see the possibility of having three levels of resolution where the number of vertices increases with the semantical description. The mobile engine (720) will handle the loading and displaying of the content supported by its hardware specifications, and the mobile decoder (710) will instantiate and filter the necessary metadata for lightweight rendering.

In this use case, we will illustrate the novelty of using this approach with the base avatar MPEG reference model. Following the same codec example shown in FIG. 6 and FIG. 7, we will have a coded representation of the MPEG reference avatar model.

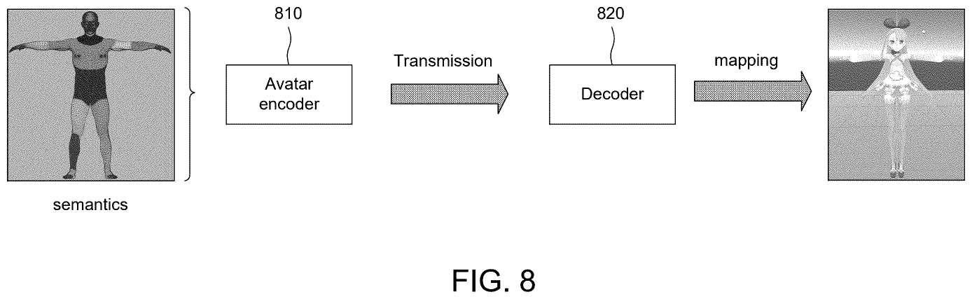

FIG. 8 illustrates semantics mapping for animation control between the MPEG reference model and VRM model, according to an embodiment. VRM is a file format for handling human-like 3D avatar (3D model) data for VR applications and is based on glTF2. The VRM body semantics are illustrated in Table 8.

TABLE 8
VRM Body Semantics

Hips
Spin
Chest
Upper Chest
Left Arm
Shoulder
Upper Arm
Lower Arm
Hand
Right Arm
Shoulder
Upper Arm
Lower Arm
Hand
Left Leg
Upper leg
Lower leg
Foot
Toes
Right Leg
Upper leg
Lower leg
Foot
Toes

In particular, FIG. 8 illustrates the encoding (810) of avatar semantical features of a MPEG reference model into a glTF file. The glTF file is transmitted to a decoder that decodes (820) the semantical features of body parts and transcodes the semantical features from the MPEG model to a different model (VRM). This allows the avatar encoder to transmit an animated base model which is known and permits the decoder and engine side to map the animated base model onto a new propriety model (VRM model). The mapping is performed on the engine or application side, and its objective is to correlate the semantical body parts between different formats and allow an exchange of animation as if it was a mirror scenario.

The following example describes the glTF format of FIG. 8. In this example, an MPEG avatar is described (i.e., isAvatar=True, format=1). It is based on the MPEG reference model (“Morgan”) which is an articulated humanoid model. The skeleton of this model is described by “semantics”, “joints”, “bones” and “bone_influence”.

The attribute “semantics” is a list of joint names. The attribute “joints” is a list of three-dimensional vectors, e.g., [0.0, 0.0, 0.0], each vector representing the x, y and z coordinates of the corresponding joint. The attribute “bones” is a list of tuples that contain joint indices, e.g., (0,1) represents a pair of joints with indices zero and one, which form a single “bone”. For simplification the “bone_influence” attribute is not complete and only provides an example for one vertex, e.g., vertex with index 0 (first element of the tuple (0, [0, 1], [0.5, 0.5]) indicates the index has the bones indices 0 and 1 (second element of the tuple [0, 1]), where each bone is associated with a weight of 0.5, third element of the tuple is [0.5, 0.5], which means that when bone 0 or 1 has a transformation, vertex zero will be impacted with 0.5 units of the bone transformations matrix). This representation will be similar for all vertices of the mesh, hence the simplification.

```
″nodes″: [
  {
    ″extensions″: {
      ″MPEG_node_avatar″: {
        ″isAvatar″: True,
        ″format″: 1,
        ″model″ : [{
          ″name″: ″MORGAN″,
          ″type″: [″humanoid″, ″Articulated″],
          ″skeleton″: [
            {
              ″semantics″:[″Hips″, ″UpperLeg_Left″, “LowerLeg_Left”, “Foot_Left””,
“UpperLeg_Right”, “LowerLeg_Right”, “Foot_Right”, “Spine”, “Chest”, “UpperChest”,
“Neck”, “Head”, “Eye_Right”, “Jaw”, “Eye_Left”, “Shoulder_Left”, ...],
              ″joints″:[[0.0,0.0,0.0], [−0.089999907, 0.06951081, −0.012969827], [−
3.6810326e−09, 0.34292775, −8.1619689e−09], [−2.6078954e−08, 0.30331337, 3.6180154e−08],
[0.090000153, 0.06951084, −0.012967926], [9.1393204e−09, 0.34292778, 9.8767421e−09], [−
5.9370795e−08, 0.30331355, −9.3613926e−09], [−2.5399265e−07, −0.11947887, 0.025937753],
[−3.126388e−15, 0.15518206, 1.192092e−09], [−1.9547208e−15, 0.096603058, 1.1041333e−09],
[2.9012837e−09, 0.11037513, −0.015938893], [1.8501332e−10, 0.14005938, −2.144948e−
09],[0.026118824, 0.096537694, 0.025297057], [0.000883931, 0.13348749, −0.050703958], [−
0.027002752, 0.096941978, 0.025406796], [−0.077003337, 0.052138112, 0.0079694372]],
                ″bones″:[(0,3), (0,6), (0,9), (1,4), (2,5), (4,7), (5,8), (7,10), (8,11), (9,12),
(9,35), (10,13), (11,14), (11,15)]
                ″bone_influence″:[(0,[0,3],[0.5,0.5]), ...]
            }
          ],
      }
    }
  }
]
```

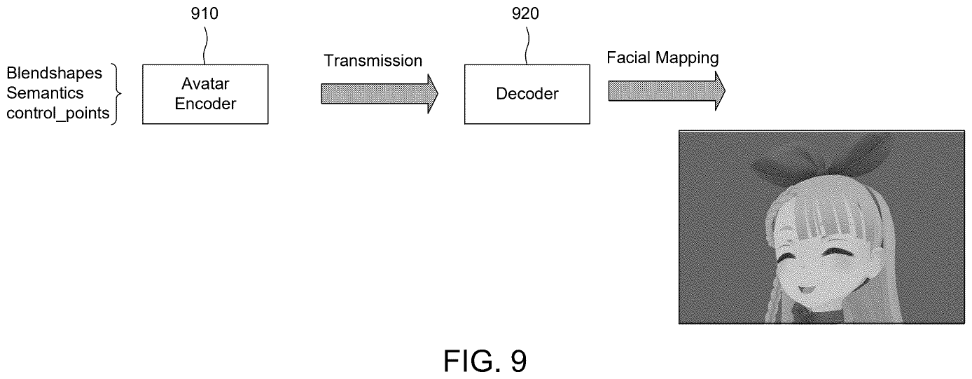

FIG. 9 demonstrates another use case where it uses blend shapes mapping, according to an embodiment. In particular, FIG. 9 illustrates semantic blend shapes for facial mapping for animation control between a MPEG reference model and VRM model. The avatar features “blendshapes”, “semantics” and “control_points” are encoded (910) and transmitted. At the client side, the decoder decodes (920) the glTF file and transcodes (facial mapping) to a new format (VRM format). Blend shapes can be seen as deformation and they produce high-level control for known animations, such as blinking left eye or smiling. The engine side will have the goal of mapping from the proposed format to VRM format.

In Table 9, the FACS is an expression shape naming defined and used in anatomy to classify facial motions. The Morgan shape column is an adaptation of such naming convention to a 3D model of a face. Shapes are separated into Left (“_L”) and Right (“_R”) components, and sometimes these last components are split into (“_1”) and (“_2”) sub-components to increase the naming precision.

TABLE 9

| Acition | | |
|---|---|---|
| Units | | |
| (AU) | FACS Name | Morgan shape |
| 1 | Inner Brow | AU1_Inner_Brow_Raiser_L1 + L2 + R1 + R2 |
| | Raiser | |
| 2 | Outer Brow | AU2_Outer_Brow_Raiser_L1 + L2 + R1 + R2 |
| | Raiser | |
| 4 | Brow | AU4_Brow_Lowerer_L + R |
| | Lowerer | |
| 5 | Upper Lid | AU5_Upper_Lid_Raiser_L + R |
| | Raiser | |
| 6 | Cheek Raiser | AU6_Cheek_Raiser_L + R |
| 7 | Lig | AU7_Lid_Tightener_L + R |
| | Tightener | |
| 9 | Nose | AU9_Nose_Wrinkler_L + R |
| | Wrinkler | |
| 10 | Upper Lip | AU10_Upper_Lip_Raiser_L + R |
| | Raiser | |
| 11 | Nasolabial | AU11_Nasolabial_Deepener_L + R |
| | Deepener | |
| 12 | Lip Corner | AU12_Lip_Corner_Puller_L + R |
| | Puller | |
| 14 | Dimpler | AU14_Dimpler_L + R |
| 15 | Lip Corner | AU15_Lip_Corner_Depressor_L + R |
| | Depressor | |
| 16 | Lower Lip | AU16_Lower_Lip_Depressor_L |
| | Depressor | |
| 18 | Lip Pucker | AU18_Lip_Pucker |
| 20 | Lip | AU20_Lip_Stretcher_L + R |
| | Stretcher | |
| 22 | Lip | AU22_Funneler |
| | Funneler | |
| 23 | Lip | AU23_Lip_Tightener |
| | Tightener | |
| 24 | Lip Pressor | AU24_Lip_Pressor |
| 26 | Jaw Drop | AU26_Jaw_Drop |
| 27 | Mouth | AU27_Mouth_Stretcher |
| | Stretch | |
| 28 | Lip Suck | AU28_Lip_Suck_Low + Up |
| 29 | Jaw Thrust | AU29_Jaw_Thrust |
| 30 | Jaw | AU30_Jaw_Sideways_L + R |
| | Sideways | |
| 31 | Jaw | AU31_Jaw_Clencher |
| | Clencher | |
| 34 | Cheek Puff | AU34_Cheek_Puff_L + R |
| 38 | Nostril | AU38_Nstril_Dilator |
| | Dilator | |
| 43 | Eyes Closed | AU43_Eyes_Closed_L + R |
| 61 | Eyes Turn | AU61_Eyes_Turn_Left |
| | Left | |
| 62 | Eyes Turn | AU62_Eyes_Turn_Right |
| | Right | |
| 63 | Eyes Up | AU63_Eyes_Up |
| 64 | Eyes Down | AU64_Eyes_Down |

Table 10 lists the VRM blend shape names, which can be used at the application side to perform the mapping between different formats.

TABLE 10
VRM Blend Shape Names

Mouth_angry
Mouth_smile
Mouth_spear
Eye_blink
Eye_smile
Eye_calm
Eyebrow_serious

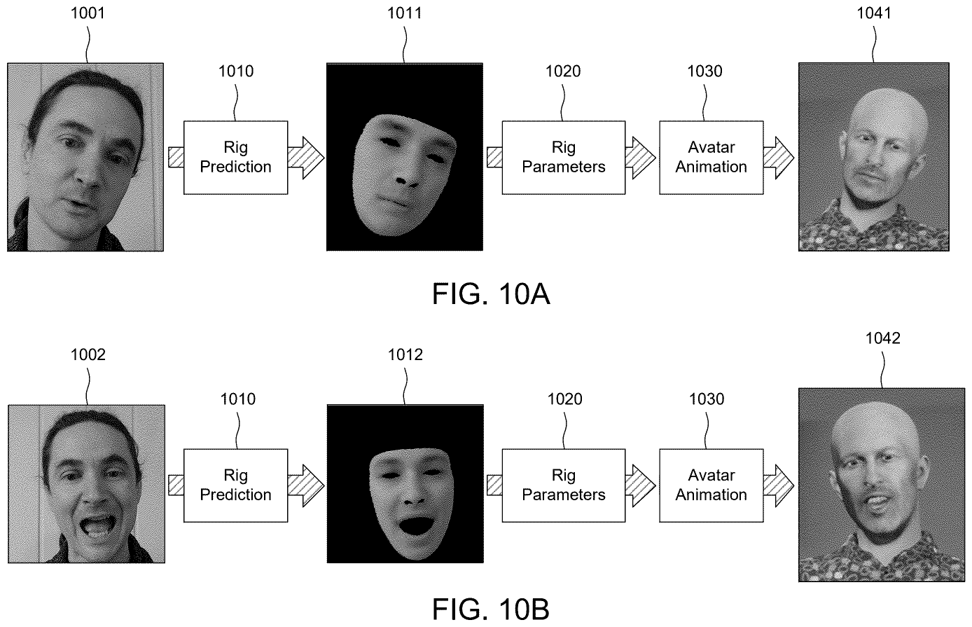

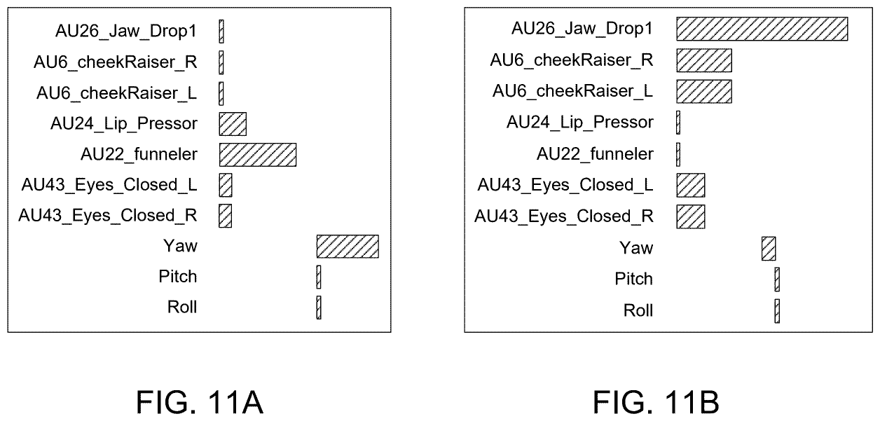

FIG. 10 illustrates a real-time scenario of semantical mapping and motion transfer using the MPEG reference model, according to an embodiment. The input user expression (1001, 1002) is captured from a camera, with the face parameters being extracted (1010) and used to map the MPEG reference face model (1011, 1012) to match the input user expression. The mapped face model is then translated into control_points or blend shapes (Rig parameters), for example, as illustrated in FIG. 11A and FIG. 11B for FIG. 10A and FIG. 10B, respectively.

FIG. 11A and FIG. 11B is a visual illustration of blendshape weights used to produce the rendering in FIG. 10A and FIG. 10B, respectively, where the name is a semantical description and the bar represents the weight used, e.g., the weights are scalar values that range between zero and one, and the final three attributes “Yaw”, “Pitch” and “Roll” are global rotation parameters of the face/head model. The rig parameters (1020) are transmitted to an animation engine (1030, e.g., Unity, Unreal, blender) to drive a 3D realistic character (1041, 1042). The MPEG reference face model (1011, 1012) is used as intermediary because it facilitates the problem of the rig prediction (1010).

The following example describes the glTF format of FIGS. 10 and 11. In this example, an MPEG avatar is described (i.e., isAvatar=True, format=1). It is based on the MPEG reference model (“Morgan”) which is an articulated humanoid model. The model is indicated as (“MORGAN_FACE_MASK”) with resolution (“high-res”), which indicated to be a subset of the MPEG reference model. The skeleton of this model is described by “semantics”, “joints”, “bones” and “bone_influence”.

```
″nodes″: [
  {
    ″extensions″: {
      ″MPEG_node_avatar″: {
        ″isAvatar″: True,
        ″format″: 1,
        ″model″ : [{
          ″name″: ″MORGAN_FACE_MASK″,
          ″type″: [″humanoid″, ″Articulated″],
          ″resolution″ : [″high-res″]
          ″skeleton″: [
            {
              ″semantics″: [“Head”, “Eye_Right”, “Jaw”, “Eye_Left”],
              ″joints″: [[1.8501332e−10, 0.14005938, −2.144948e−09], [0.026118824,
0.096537694, 0.025297057], [0.000883931, 0.13348749, −0.050703958], [−0.027002752,
0.096941978, 0.025406796]],
              ″bones″:[(0,1), (0,2), (0,3)]
              ″bone_influence″:[(0,[0,1], [0.0,1.0]), ...]
            }
          ],
      }
    }
  }
]
```

It should be noted that high-level semantic description is less costly in terms of network transmission and also enables easy transcoding between different formats. In this example, there are only a total of 10 scalars (floats) parameters to send across the network, otherwise, the full mesh would need to be sent for every frame, which can bring the bitrate transmission time higher and with eventual loss (depending on compression parameters).

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining, from a plurality of formats, a format used to represent an avatar, from a description for an extended reality scene;
obtaining from said description at least a type of avatar; and
reconstructing said avatar, based on said format and said at least a type of avatar.

2-3. (canceled)

4. The method of claim 1, wherein said at least a type includes at least one of Humanoid, Non-Humanoid, Animal, Aquatic, Aerial, Terrestrial, Subterranean and Arboreal.

5. The method of claim 1, further comprising obtaining a skeletal structure for said avatar.

6. The method of claim 5, wherein description for said skeletal structure includes at least joint names, 3D positions of joints, bone structure, influence between bones and geometry, and high level semantic control points.

7-9. (canceled)

10. The method of claim 1, further comprising mapping to represent said avatar in another format.

11. (canceled)

12. An apparatus, comprising:
one or more processors; and
at least one memory coupled to said one or more processors, wherein said one or more processors are configured to:
obtain, from a plurality of formats, a format used to represent an avatar, from a description for an extended reality scene;
obtain from said description at least a type of avatar; and
reconstruct said avatar, based on said format and said at least a type of avatar.

13-14. (canceled)

15. The apparatus of claim 12, wherein said at least a type includes at least one of Humanoid, Non-Humanoid, Animal, Aquatic, Aerial, Terrestrial, Subterranean and Arboreal.

16. The apparatus of claim 12, further comprising obtaining a skeletal structure for said avatar.

17. The apparatus of claim 16, wherein description for said skeletal structure includes at least joint names, 3D positions of joints, bone structure, influence between bones and geometry, and high level semantic control points.

18-20. (canceled)

21. The apparatus of claim 12, further comprising mapping to represent said avatar in another format.

22-23. (canceled)

24. A method, comprising:
indicating a format, of a plurality of formats, used to represent an avatar, in a description for an extended reality scene;
indicating at least a type of avatar in said description;
generating data representative of said avatar based on said format and said at least a type of avatar; and
indicating said data representative of said avatar in said description.

25. The method of claim 24, wherein said at least a type includes at least one of Humanoid, Non-Humanoid, Animal, Aquatic, Aerial, Terrestrial, Subterranean and Arboreal.

26. The method of claim 25, further comprising obtaining a skeletal structure for said avatar.

27. The method of claim 26, wherein description for said skeletal structure includes at least joint names, 3D positions of joints, bone structure, influence between bones and geometry, and high level semantic control points.

28. The method of claim 24, further comprising encoding said description.

29. An apparatus, comprising:
one or more processors; and
at least one memory coupled to said one or more processors, wherein said one or more processors are configured to:
indicate a format, of a plurality of formats, used to represent an avatar, in a description for an extended reality scene;
indicate at least a type of avatar in said description;
generate data representative of said avatar based on said format and said at least a type of avatar; and
indicate said data representative of said avatar in said description.

30. The apparatus of claim 29, wherein said at least a type includes at least one of Humanoid, Non-Humanoid, Animal, Aquatic, Aerial, Terrestrial, Subterranean and Arboreal.

31. The apparatus of claim 30, further comprising obtaining a skeletal structure for said avatar.

32. The apparatus of claim 31, wherein description for said skeletal structure includes at least joint names, 3D positions of joints, bone structure, influence between bones and geometry, and high level semantic control points.

33. The apparatus of claim 29, wherein said one or more processors are further configured to encode said description.
